(19) United States
(12) Patent Application Publication
(10) Pub. No.: US 2010/0002451 A1
(43) Pub. Date: Jan. 7, 2010

(54) TINTED AND FROSTED OUTER BULB COVER FOR LIGHTS

(76) Inventor: Elaine M. Reynolds, Dana Point, CA (US)

Correspondence Address: DONALD W. MEEKER, 924 EAST OCEAN FRONT, # E, NEWPORT BEACH, CA, 92661, US

(21) Appl. No.: 12/168,734

(22) Filed: Jul. 7, 2008

(51) Int. Cl. F21V 3/00

(52) U.S. Cl. 362/363

(57) ABSTRACT

A non-shattering outer cover bulb is installed over a non-incandescent light. Cylindrical or conical reflective sides reflect the light out of an end opening. A tinted lens with outer frosting is removably attached over the end opening. The cover bulb clamps onto or screws onto an existing light.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to socket-engaging light bulb guards and particularly to an outer bulb cover which surrounds a compact fluorescent light tube or a Light Emitting Diode (LED) light or other high intensity non-incandescent lights and is preferably made of shatterproof polycarbonate glass and/or glass substitute; the outer bulb cover comprising conical or cylindrical or other shaped sides preferably coated with reflective surfaces to reflect more of the light out of the end of the outer bulb for a spot light or flood light effect, a removable replaceable tinted and frosted circular end lens for creating special lighting and to hide the fluorescent tube inside when the light was not turned on.

2. Description of Related Art Including Information Disclosed Under 37 CFR 1.97 and 1.98

Compact fluorescent lights have proven to be far more energy efficient than incandescent lights and are replacing incandescent bulbs for many applications. Commonly used incandescent light bulbs utilize a substantial amount of electricity and create excessive heat. The standard incandescent bulbs are being replaced by more efficient compact fluorescent lights and/or LED lights which produce more light, and use less electricity while generating less heat. Compact fluorescent lights have been developed which are adapted to be used in the socket of a conventional incandescent lamp fixture, such as a table lamp or an overhead light fixture by use of a threaded socket plug pins and other variations of sockets which screw or clip into the conventional sockets of an incandescent lamp fixture. Compact fluorescent lights have even been made in the shape of a conventional light bulb. Compact fluorescent lights are considerably more expensive than incandescent bulbs. They explode when broken releasing mercury into the air, and produce a very unpleasant glaring white light when lighted.

New LED lights have greater brightness now and also have advantages over incandescent lights as do the compact fluorescent lights. The LED lights also have brightness and color problems that are often not desirable.

The prior art patents do not effectively deal with the problems inherent in compact fluorescent lights and LED lights.

U.S. Pat. No. 4,745,323, issued May 17, 1988 to Northrop, illustrates a compact fluorescent lamp of the twin tube or double twin type which is protected by an outer envelope mounted to the fluorescent lamp or the housing which contains the fluorescent lamp ballast. In a preferred embodiment the outer envelope is in the shape of an incandescent lamp envelope. The outer envelope may be coated or colored for practical or aesthetic purposes. If certain coatings are used on the envelope, then the light which the viewer sees may be made colored and warmer, simulating incandescent light. This is close, but mentions coatings rather than a tinted lens and does not mention a tinted lens frosted on the outside.

U.S. Pat. No. 6,739,737, issued May 25, 2004 to Yu, claims a lamp body of the compact spot and flood light type which is suitable for use with a compact fluorescent light source, wherein the lamp body includes a lamp head, a lampshade for reflecting the light emitted from the light source, and an adapter connected to the lamp head, wherein the lampshade is formed by the integration of at least two coaxial conical surfaces with different vertex angles.

U.S. Pat. No. 4,750,096, issued Jun. 7, 1988 to Lim, provides a fluorescent light fixture which employs a lamp fitting, electrical ballast, and a base which are inter linked, to mechanically and electrically, to connect to a fluorescent lamp to an electrical socket. A heat conductive housing and a spacer mechanism transport heat from the ballast to the exterior of the lighting fixture when the same is in operation.

U.S. Pat. No. 5,720,548, issued Feb. 24, 1998 to Geary, illustrates a high luminance fluorescent-lighting adaptor assembly for a fluorescent lamp which has at least one light-emitting tube, a base, and electrical contacts on said base includes an electrical adaptor and a heat sink. The electrical adaptor includes an enclosure and electrical sockets configured to receive the lamp contacts on the enclosure. The enclosure defines at least two housing portions radially separated by at least one window and a ballast in at least one of the housing portions. The heat sink includes a wall surrounding the light-emitting tube, a heat coupling surface of the wall facing the light-emitting tube and configured to couple heat between the light-emitting tube and the wall, and a heat dissipation surface. The heat dissipation surface of the wall is positioned in the window between the enclosure portions and is configured to dissipate heat to the atmosphere. An optional lens or cover may be snap-fitted across the opening of reflector assembly. The lens may be of a clear transparent configuration or may include stipples or the like to provide optical features in order to make the light generated by the lighting adaptor assembly more or less diffuse.

U.S. Pat. No. 5,189,339, issued Feb. 23, 1993 to Peshak, claims fluorescent lamp assemblies with screw-in bases and solid-state ballasts, useful indoors or outdoors, such as in reflector spotlight or floodlight or table lighting. A two-piece non-conductive housing is retained simply by a pair of screws or the like, and laterally surrounds a fluorescent lamp assembly and its ballast, and also has a ratcheting screw-in Edison base on one end and a lens covering the light-emitting opposite end. Families of such lamp assemblies with different wattages and/or different beam-spreads are suitable for such usage, and for use in canister-like ceiling or wall fixtures.

U.S. Pat. No. 5,363,295, issued Nov. 8, 1994 to DeKleine, provides a compact fluorescent lamp reflector. A replacement fluorescent lighting device includes a fluorescent lamp having a plurality of parallel tubes elongated along an axis and a reflector with an annual reflecting inner surface surrounding the tubes. The inner surface includes at least one surface, or surface segment, that is defined by a geometric curve rotated at least partially about a given axis, with the curve having a focal point that is laterally offset from the given axis in order to have a focal ring segment to enhance light emitted by the surface of the fluorescent tubes. Multiple surface segments are defined about an axis offset from the lamp axis of elongation and spaced radially around the fluorescent lamp. These segments are positioned at major lumen output lobes of the lamp.

U.S. Pat. No. 4,520,436, issued May 28, 1985 to McNair, shows a lamp apparatus having a reflective housing body, a conventional screw-type plug for use with an Edison-type socket, and a fluorescent lamp source. The reflector housing has a cone with a smaller end and a larger end. An inward curved axial extension on the smaller end fits tightly over end portion of body. Inwardly depressed beads or detents capture the end portion of body when the body is pushed into the reflector beyond the detents with a snap action. A disk-shaped, fresnel, lens is received within a lens-mounting means, which includes a stepped recess for retaining the lens formed at larger end of reflector.

U.S. Pat. No. 4,746,840, issued May 24, 1988 to Lim, concerns a fluorescent reflector lamp assembly for use in screw-type sockets for conventional incandescent bulbs includes an Edison-type base connector, a generally annular ballast housing, a reflective shell formed of a heat-conducting material and having a tubular base adapted to seat within a central recess encompassed by the ballast housing, and a receiving member mounted in the recess to receive a fluorescent lamp whose base abuttingly engages a substantial area of the sidewall of the reflector base. A transparent protective cap or lens is sealingly mounted across the enlarged open end, or mouth, of reflector shell.

U.S. Pat. No. 5,546,291, issued Aug. 13, 1996 to Simes, relates a conversion kit assembly for use with a light bulb such as a compact fluorescent bulb provides the light bulb with the appearance of a different type of bulb as well as the ability to adjust the illumination by varying the position of the conversion kit assembly on the light bulb. The conversion kit assembly includes a collar having a hollow interior for receiving the light bulb and resilient prongs for engaging the light bulb to maintain the collar in a desired mounted position on the light bulb. The resilient prongs can comprise wire loops formed at the opposite ends of a length of wire mounted within the collar, or leaf springs mounted within the hollow interior of the collar. A threaded base of the collar releasably receives the threaded base of a glass envelope having a hollow interior for receiving a portion of the light bulb mounted within the collar. The glass envelope has the shape and appearance of a particular type of light bulb, so that a compact fluorescent bulb can assume the appearance of a floodlight, a spotlight or a rounded globe. The glass envelopes can be made of clear glass, white glass or other colors, as desired. Where desired, the glass envelope may be configured to provide a lens effect so that even greater illumination is provided.

U.S. Pat. No. 4,763,233, issued Aug. 9, 1988 to Poyer, shows an economical and rugged outdoor marine lighting fixture designed particularly for dock-side use. The fixture's major components include a funnel-shaped main housing of polyvinyl chloride having a cylindrical upper end and a cylindrical lower end of reduced diameter; a main housing extension of polyvinyl chloride having the same diameter as the lower end of said main housing and having an annular ring projecting from its inner wall; a hollow cylindrical housing sized to fit into the upper cylindrical end of said main housing; a U-shaped fluorescent lamp; a socket for said lamp; a 120 volt transformer; a circular socket mounting bracket sized to fit snugly onto the annular ring of the main housing extension and carrying the fluorescent lamp socket and the transformer; a dished reflector surrounding the lower end of the lamp and whose outer edge is secured between the lower end of the cylindrical housing and the flared wall of the main housing; and a flat circular transparent lens bonded to the upper end of said main housing. While the lens is shown as a flat circular disk of clear transparent plastic material, lenses having other shapes and colors may be used.

U.S. Pat. No. 6,296,375, issued Oct. 2, 2001 to Sung, concerns a compact fluorescent lamp having a detachable cover. The cover may be transparent or, preferably, frosted or clouded to diffuse the radiance emanating from tubes. The compact fluorescent lamp includes a housing for enclosing a ballast and, optionally, a starter, a fluorescent light tube attached to the housing and electrically connected to the ballast; and a base electrically connected to the ballast and physically attached to the housing for connecting the lamp to an electrical receptacle. The housing is provided at an upper edge thereof with male or female mating elements, for example, threads, tabs, or slots. The lamp further includes a translucent cover or shroud for surrounding the fluorescent tube, having a closed form and being open at an end thereof, and being provided at the open end with male or female mating elements cooperative with the mating elements on the housing to directly, positively, and detachably attach the cover to the housing.

U.S. Pat. No. 4,939,420, issued Jul. 3, 1990 to Lim, describes a fluorescent reflector lamp assembly comprising a ballast transformer for fluorescent reflector lamp assemblies used in screw-type sockets for conventional incandescent bulbs. Further in practice, a transparent protective cap or lens is sealingly mounted across the enlarged open end, or mouth, of the reflector.

U.S. Pat. No. 5,390,096, issued Feb. 14, 1995 to DeKleine, discloses a replacement fluorescent lighting adaptor for adapting a fluorescent lamp to an incandescent lamp connector. The adaptor includes a base defined by an annular inner wall and an annular outer wall surrounding the inner wall and spaced from the inner wall defining a cavity. The inner wall includes a contact assembly for making electrical contact with the fluorescent lamp contacts and a portion to receive the fluorescent lamp base. A reflector including a narrow neck portion and a longitudinally, outwardly expanding portion is fitted to the base receiving portion by the narrow neck portion. The cavity includes a first cavity portion between the lamp base-receiving portion and the outer wall in which an annular electrical ballast member is positioned. The outer wall is spaced from the reflector in order to improve heat dissipation of the electrical ballast. An annular capacitive device is positioned in a second cavity portion between the contact assembly and the outer wall. An optional lens may be relatively clear in order to retain the light reflected by reflector collimated in a beam to thereby make the lighting adaptor a spotlight. The lens may, alternatively, contain stipples in order to diffuse the light reflected by reflector, thereby making the lighting adaptor a floodlight.

U.S. Pat. No. 7,217,007, issued May 15, 2007 to Choi, shows a dark-sky friendly lamp-housing combination for use with a light fixture. The combination uses a standard lamp having a light element and a base section. The base section includes a neck attached to the light element and a connector that is received in a socket of a light fixture. A housing attached to the neck is adapted to direct light from the light bulb in a predefined direction to reduce light pollution. In one aspect, the housing is rotatable about the base section so that the direction of illumination can be adjusted as desired.

U.S. Pat. No. 5,651,609, issued Jul. 29, 1997 to Pelton, describes a fluorescent lamp housing assembly capable of providing convection cooling to the lamp and the ballast. The lens of the invention includes two distinct portions, a central portion and an apertured portion. The housing assembly further includes apertures so that air mass is able to freely move up through the assembly and out ventilation apertures.

U.S. Pat. No. 5,608,289, issued Mar. 4, 1997 to O'Carroll, discloses a fluorescent lamp adapter with a shell form ballast. The shell form ballast has rounded corners for positioning inside a ballast housing for use with a fluorescent light bulb adapter. The ballast has rounded outer corners to meet both long-term life and power requirements, and spatial design constraints of a fluorescent lamp adapter assembly for use in an incandescent lighting fixture, and particularly for use in a recessed incandescent lighting fixture. The rounded outer corners of the ballast provide the ability for the shell form ballast to fit into a hollow housing for use in the recessed lighting fixture while simultaneously providing the shell form ballast a snug fit in the hollow housing, thereby minimizing gap growth. Generally, the lamp holder portion includes a frusto-conical retaining member and a rounded translucent cover member, which retains the fluorescent lamp in the adapter assembly.

U.S. Pat. No. 7,053,540, issued May 30, 2006 to Bobel, is for an energy efficient fluorescent reflector lamp includes a compact fluorescent light source enclosed in a reflector with a defined cavity and circumferential rim defining a light emitting opening, and a circumferential flange at a mating opening. The reflector cavity enclosed with a lens at the rim, has an interior wall as a reflective surface for directing light out from light emitting opening. The fluorescent light source is attached to a base located inside the reflector cavity and located inside the mating opening. The circumferential flange diameter is larger than a diameter of the mating opening. The base is assembled and locked together with a ballast housing of defined space sufficient to accommodate an electronic ballast and an electricity supply base. The ballast energizes the fluorescent light source to emit light, and the ballast includes power input terminals connected to said electricity supply base and output terminals connected to said fluorescent light source. The fluorescent reflector lamp has luminous efficacy which exceeds that of corresponding halogen reflector lamps while having an overall outline fitting substantially within the ANSI specified outline for PAR lamps.

U.S. Pat. No. 4,748,380, issued May 31, 1988 to MacDonald, provides a fluorescent lamp assembly having an electronic ballast circuit. A ballast circuit transformer is mounted on a metallic plate having a recess complementary to the transformer, and the metallic plate suppresses conducted RFI. A lamp cover is attached to the metallic plate and heat from the ballast circuit transformer is dissipated by the metallic plate and lamp cover.

U.S. Pat. No. 4,878,159, issued Oct. 31, 1989 to Blaisdell, is for a fluorescent lamp having removable jacket. The fluorescent lamp unit includes an adapter which contains a ballast, a fluorescent lamp electrically coupled to the adapter, a compressible gasket member and a jacket. The jacket is adapted to be easily removed from the unit upon failure of the fluorescent lamp. An inwardly protruding ledge which extends radially around the interior of the jacket provides a bearing surface for contacting the gasket member. Preferable, the lower portion of the jacket member is provided with a pair of diametrically opposed grooves for engaging a pair of lugs formed in the housing of the adapter. Preferably, each of the grooves has an offset portion and a stop for locking the lugs in place and thereby preventing rotation of the jacket member with respect to the adapter until the gasket member is compressed.

U.S. Pat. No. 7,178,944, issued Feb. 20, 2007 to Walton, is for a lighting apparatus and a method of enhancing illumination by a variety of lamp types through the use of reflective technologies, for example, replacement of expensive high intensity density or mercury vapor lamps with low wattage fluorescent tubes having at least one and in some cases, up to three reflective surfaces for focusing otherwise lost light toward a target illumination area. Further, the placement of light sources at the focal point of said reflective surfaces aids in optimizing the amount of light focused in a desired direction.

U.S. Patent Application #20070041200, published Feb. 22, 2007 by Walton, is for a lighting apparatus and a method of enhancing illumination by a variety of lamp types through the use of reflective technologies, for example, replacement of expensive high intensity density or mercury vapor lamps with low wattage fluorescent tubes having at least one and in some cases, up to three reflective surfaces for focusing otherwise lost light toward a target illumination area. Further, the placement of light sources at the focal point of said reflective surfaces aids in optimizing the amount of light focused in a desired direction.

U.S. Pat. No. 6,974,233, issued Dec. 13, 2005 to Aubrey, relates retrofit fluorescent lighting fixtures for installation into a surface mounted cylindrical lighting fixture of the square or cylindrical shape. A 4-wire assembly is used for replacing conventional incandescent light bulbs with fluorescent light bulbs in existing lighting fixtures recessed downlights, in particular. The retrofit lighting fixtures include, inter alia, a threaded connector, a ballast, a heat exchanger, a fluorescent light source connector and a threaded body for receiving a reflector glass.

U.S. Pat. No. D302,472, issued Jul. 25, 1989 to MacDonald, shows the ornamental design for a compact fluorescent reflector lamp.

U.S. Pat. No. D275,327, issued Aug. 28, 1984 to Young, describes the ornamental design for a compact fluorescent lamp unit having a cylindrical cover.

What is needed is a means to convert the light from a compact fluorescent light which fits into a standard Edison socket into light of a similar hue produced by an incandescent bulb and convert LED lights having various connectors by use of a tinted lens and/or a frosted diffusion lens to diffuse or soften the outgoing light or color the light as desired for special effects or special occasions when the internal compact fluorescent or LED light is lighted, and the frosted lens further serves to hide the compact fluorescent tube or LED light when the light is not lighted.

### BRIEF SUMMARY OF THE INVENTION

An object of the present invention is to provide an outer cover bulb which serves as a shield and diffusion casing which surrounds a compact fluorescent light or LED light or other non-incandescent light and is preferably made of shatterproof polycarbonate to prevent shattering and comprises conical or cylindrical or other shaped sides preferably coated with reflective surfaces to reflect more of the light out of the end of the outer cover bulb for a spot light or flood light effect and a removable replaceable tinted and frosted circular end lens for creating special lighting effects and to hide the light inside when the light was not turned on.

A related object of the present invention is provide the tinted lens to convert the light from a compact fluorescent light which fits into variations of standard Edison sockets or LED lights fitting into various sockets or other non-incandescent lights into light of a similar hue produced by an incandescent bulb by use of the tinted lens and/or a frosted diffusion lens to diffuse or soften the outgoing light or color the light as desired for special effects or special occasions when the internal light is lighted, and the frosted lens further serves to hide the compact fluorescent tube when the light is not lighted.

Another object of the present invention is to provide a means to screw the outer cover bulb onto a threaded neck adjacent to the compact fluorescent tube or LED light or other non-incandescent light or a neck with a clamp that would attach to the neck on a standard compact fluorescent threaded end LED light, or other non-incandescent light, or built as one complete unit.

In brief, a non-shattering outer cover bulb or glass and/or glass substitute is installed over a compact fluorescent tube or LED light or other non-incandescent light. Cylindrical or conical or other shaped reflective sides of the outer cover bulb reflect the light from the compact fluorescent tube out of an end opening of the outer cover bulb. A tinted lens with outer frosting is removably attached over the end opening of the cover bulb. The cover bulb clamps onto or screws onto an existing fluorescent light, or LED light, or other non-incandescent light, or as one complete unit.

An advantage of the present invention is economic use of compact fluorescent lights, LED lights, or other energy efficient non-incandescent lights in all lighting fixtures without having to see the unsightliness of the tube.

Another advantage of the present invention is that the lens reduces the normal white glare caused by most non-incandescent lights.

One more advantage of the present invention is that the lens is interchangeable with lenses of different tints and/or built as one complete unit, allowing for different effects for work lighting, holiday lighting, mood lighting, etc.

An additional advantage of the present invention is the outer cover bulb is easily and instantly removable in order to change the compact fluorescent, LED, or other light and install the outer cover bulb on the new compact fluorescent, LED, or other light.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is an exploded perspective view of a conical outer cover bulb of the present invention with the hollow body portion and tinted lens aligned for assembly over the compact fluorescent light and showing another type of compact fluorescent light with a different connector and an LED light which may all be used with the cover bulb of the present invention;

FIG. 2 is a side elevational view of the conical outer cover bulb of the present invention fully assembled over the compact fluorescent light;

FIG. 3 is an exploded perspective view of a cylindrical outer cover bulb of the present invention with the hollow body portion and tinted lens aligned for assembly over a compact fluorescent light and showing another type of compact fluorescent light with a different connector and an LED light which may all be used with the cover bulb of the present invention;

FIG. 4 is a side elevational view of a cylindrical outer cover bulb of the present invention fully assembled over the compact fluorescent light;

FIG. 5 is a partial cross-sectional view of the tinted glass lens assembly of the present invention shown installed in a ceiling recessed light fixture using a compact fluorescent light wherein gaskets are adhered between the lens and the existing light baffle and to the top of the frame;

FIGS. 6A, 6B, and 6C show three types of LED lights with different connectors which may all be used with the outer cover bulb of the present invention;

FIG. 7 is an exploded side elevational view of a normal incandescent light bulb shaped outer cover bulb of the present invention with the hollow body portion and tinted lens aligned for assembly over the compact fluorescent light;

FIG. 8 is a side elevational view of the normal incandescent light bulb shaped outer cover bulb of FIG. 7 fully assembled over the compact fluorescent light.

### DETAILED DESCRIPTION OF THE INVENTION

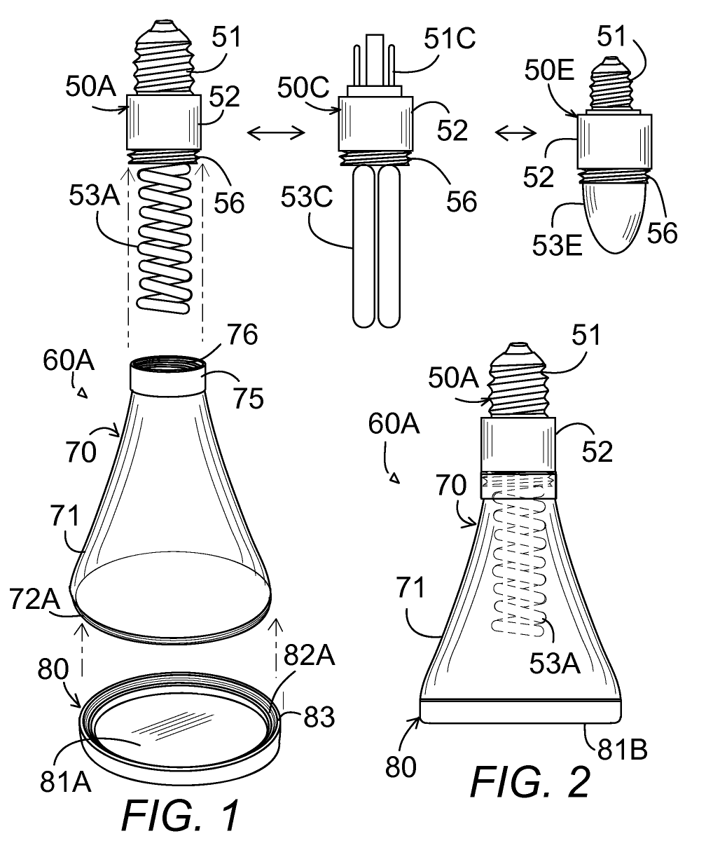

In FIGS. 1-8, an outer cover bulb device 60A and 60B for a compact fluorescent light 50A and 50B or Light Emitting Diode (LED) light 50D-50H or other non-incandescent light serves as a compact fluorescent tube shield or other light shield and as a light diffusion casing for soft light, incandescent quality light, and special colored lighting effects.

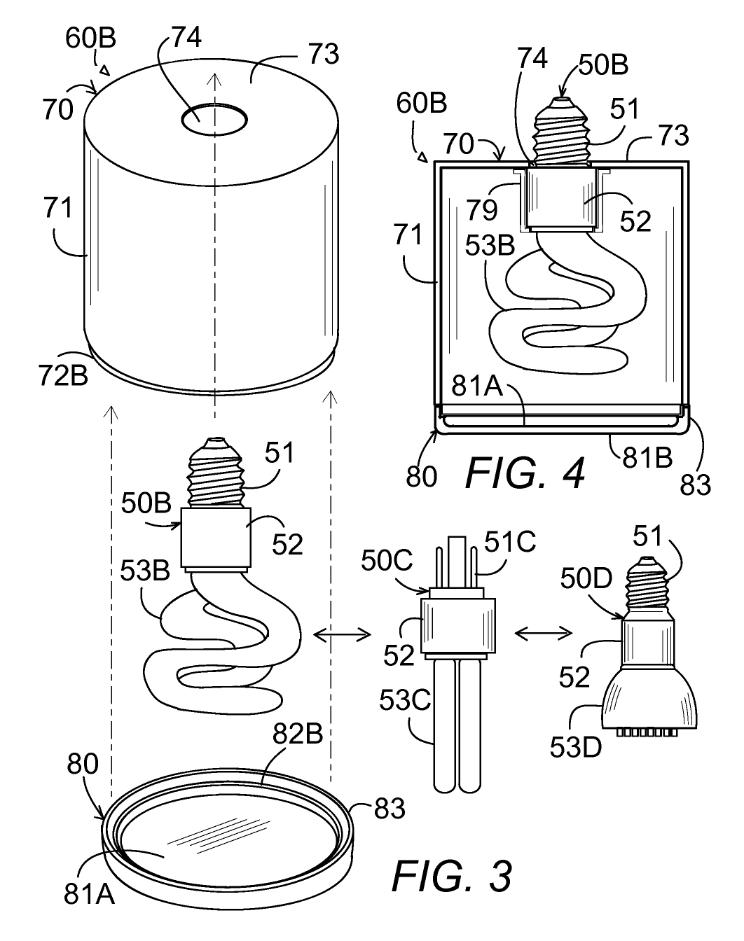

An outer cover bulb 70 removably installed over a compact fluorescent tube 53A-53C or LED light bulb 53D-53H or other non-incandescent light surrounds the compact fluorescent tube, LED or other light bulb. The outer cover bulb 70, preferably fabricated of shatterproof polycarbonate to prevent damage to the compact fluorescent tube inside, has a hollow body portion 71 that is spaced apart from and completely surrounds the compact fluorescent tube 53A-53C or LED light bulb 53D-53H or other non-incandescent light, with a first end opening 77 removably attached to the base 52 of the compact fluorescent light 50A-50C or LED light 50D-50H, and a second end opening 78 opposite the compact fluorescent tube 53A-53C, LED light bulb 53D-53H or other light thus covered. The outer cover bulb 70 admits light out of the second end opening 78. The hollow body portion 71 has a reflective surface to reflect more of the light out of the second end opening 78 for spot light and flood light effects. In FIGS. 1-5, the compact fluorescent light base 52 has a threaded end 51 for fitting into a standard light bulb socket. In FIGS. 1 and 3, an alternate compact fluorescent light base has a double pin end 51C for fitting into a fluorescent light socket. In FIGS. 1, 3, and 6 the LED light base 52 has any of a variety of connector ends 51D-51H for connecting to various fixtures.

A removable, replaceable tinted and frosted lens 80 is removably attached to the hollow body portion 71 of the outer cover bulb 70, covering the second end opening 78 so that the tinted and frosted lens 80 creates special lighting effects by altering the bright light of the compact fluorescent tube 53A-53B or LED light bulb 53D-53H or other light bulb that shines through the second end opening 78, thereby softening the light, creating incandescent light quality, or creating colored light for special effects. The tinted and frosted lens 80 has an exterior frosted surface 81B to hide the compact fluorescent tube 53A-53C or LED light bulb 53D-53H or other light bulb inside the outer cover bulb 70 when the compact fluorescent light is not lighted. The tinted and frosted lens 80 is replaceable so that any of a variety of tinted lenses may be used interchangeably on the outer cover bulb 70, allowing the outer cover bulb to serve as a compact fluorescent tube and LED shield, and as a light diffusion casing for soft light, incandescent quality light, and special colored lighting effects.

In FIGS. 1 and 2, in one embodiment, the outer cover bulb 70 has a conical hollow body portion 71 narrow at the first end opening 77 to fit the compact fluorescent light base 52, LED light base 52 or other light base and wider at the second end opening 78 so that the angle of the conical walls of the hollow body portion 71 reflect light out of the second end opening 78.

In FIGS. 3 and 4, in another embodiment, the outer cover bulb has a cylindrical hollow body portion 71, which has an annular end cap 73 over the first end opening 77 with a smaller central opening to fit the base 52 of the compact fluorescent light 50B or 50C or LED light 50D for attachment thereto.

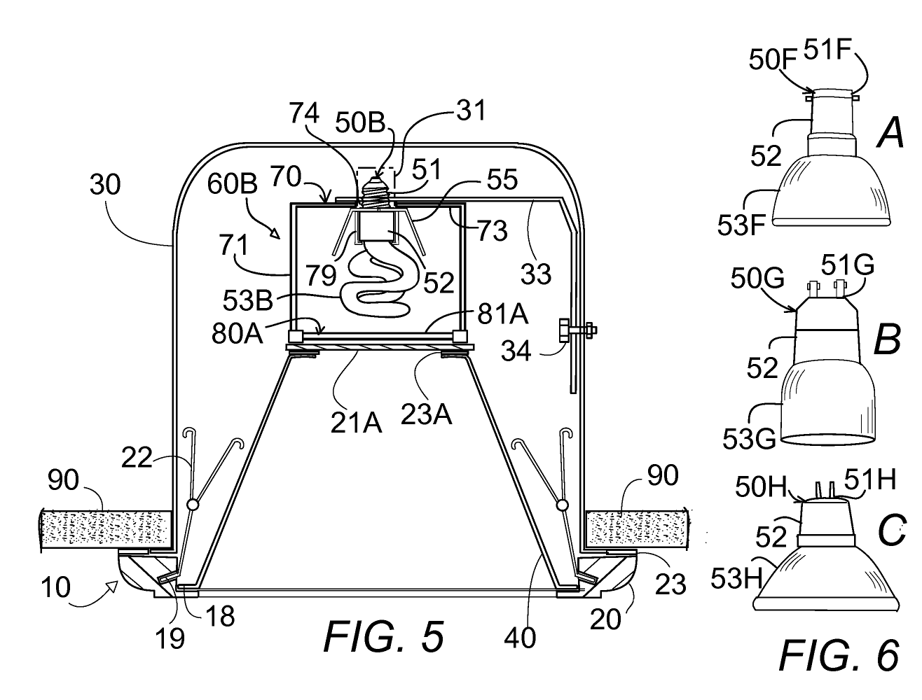

In FIG. 5, in another embodiment, the outer cover bulb device 60B has a lens assembly 10 with a frame 20 structured to fit against a ceiling 90 surface surrounding a recessed lighting opening in a ceiling 90. The recessed lighting opening houses an existing recessed lighting can 30 having a light fixture socket 31 recessed within the can to hold the compact fluorescent light 50B or LED light or other light covered by the outer cover bulb 70 in the socket. The light fixture socket 31 is suspended within the recessed lighting can 30 by an adjustable bracket 33, attached to the side of the can with a bolt 34. The frame 20 is attached to a light baffle 40 extending into the recessed lighting can 30. The light baffle has a baffle bottom opening mating with the frame 20 by resting on an inner ledge 18 of the frame 20 and a baffle top opening, with an annular gasket 23A fitted between the baffle top and a frosted lens 21A attached to the baffle 40. In one embodiment, the annular gasket 23A has adhesive on top and bottom covered with a peel off strip, which is adhered between the frosted lens 21A and the baffle 40. The baffle 40 admits light therethrough from the compact fluorescent tube 53B, LED light bulb or other light and hides the compact fluorescent tube 53B, LED light bulb or other light when it is not lighted. The baffle top opening is attached through the frosted lens 21A to the second end opening of the cylindrical hollow body portion 71 of the outer cover bulb 70.

A conical reflector 55, may be attached to the base 52 of the compact fluorescent tube 53B, LED light bulb or other light bulb surrounding the compact fluorescent tube, LED light bulb or other light to reflect light out of the second end opening. A frosted lens 21A is attached across the baffle top opening to act as the exterior frosted surface for a tinted lens 80A attached to the outer cover bulb 70.

A series of spring hooks 22 extend upwardly peripherally around the frame 20 so that the spring hooks contact the can 30 and removably retain the lens assembly 10 in the can 30 with the frame 20 contacting the ceiling 90, with an annular gasket 23 between the frame 20 and the ceiling 90. In one embodiment, the annular gasket 23 has adhesive on a bottom surface, which is normally covered by a peel off strip, and which adheres to the top of the frame 20.

In FIGS. 1, 2, 7 and 8, the base 52 of the compact fluorescent lights 50A and 50C each have a casing housing a ballast. The base may have a threaded peripheral edge 56 at the bottom of the base 52 and the LED light bulb 50E may have a base 52 with a threaded peripheral edge 56, and the top end opening 77 of the hollow body portion 71 has a mating interior threaded opening 76 so that the hollow body portion 71 reversibly screws onto and off of the base 52. The second end opening 78 of the outer cover bulb 70 has a threaded peripheral edge 72A at the bottom of the outer cover bulb and the replaceable tinted lens 80 has a side wall or ridge 83 having a mating interior threaded opening 82A so that the replaceable tinted lens 80 reversibly screws onto and off of the outer cover bulb 70.

In FIG. 4, in an alternate embodiment, the top end opening 77 of the hollow body portion 71 has a clamp 79 for removably attaching the outer cover bulb 70 to the base 52 of the compact fluorescent light 50B or 50C or LED light 50D. In FIG. 3, the second end opening 78 of the outer cover bulb 70 has a recessed peripheral ridge 72B at the bottom of the outer cover bulb 70 and the replaceable tinted and frosted lens 80 has a mating interior recessed ridge 82B so that the replaceable tinted and frosted lens 80 reversibly snaps onto and off of the outer cover bulb 70.

In FIGS. 1-4, 7 and 8, the compact fluorescent lights 50A and 50B each have a threaded end 51 for fitting into a standard light bulb socket, and in FIGS. 1 and 3, the compact fluorescent light 50C has a double pin end 51C for fitting into a fluorescent light socket. In FIGS. 1, 3, and 6, the LED lights 50D-50H each have different types of connecting ends 51D-51H for connecting into a variety of light sockets.

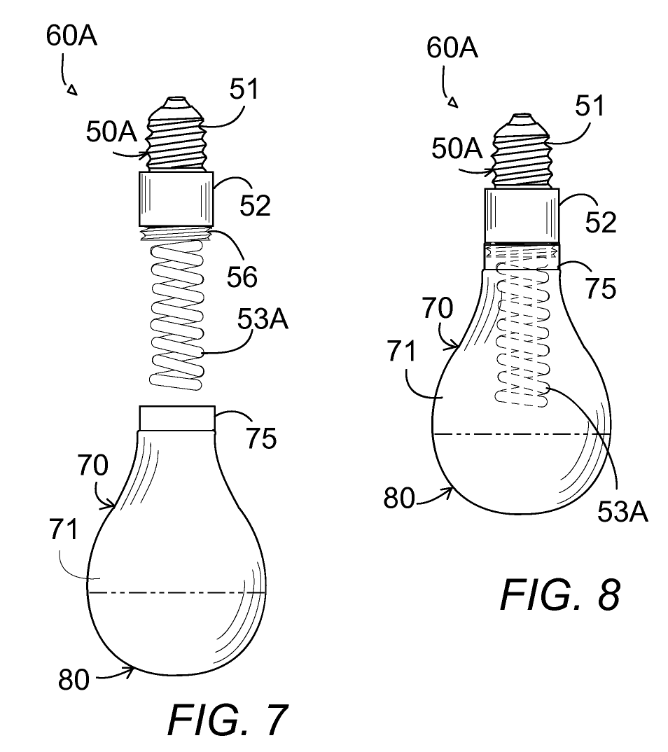

In FIGS. 7 and 8, a normal incandescent light bulb shaped outer cover bulb 70 is used wherein the hollow body portion 71 may be tinted and an optional tinted lens 80 may attach to the bottom of the hollow body portion 71 along the dashed line. A threaded collar 75 in the outer cover bulb 70 may be used to attach to the mating threaded peripheral edge 56 of the base 52 of the compact fluorescent light 50A.

The outer bulb cover of the present invention may be installed on any of a variety of types of non-incandescent lights taken from a list of non-incandescent lights comprising a compact fluorescent light, a Light Emitting Diode (LED) light, an energy saving light, a light producing a quality of light output unlike an incandescent light output, or any other type of light for which an outer cover is desired.

It is understood that the preceding description is given merely by way of illustration and not in limitation of the invention and that various modifications may be made thereto without departing from the spirit of the invention as claimed.

What is claimed is:

1. An outer cover bulb device for a variety of non-incandescent lights, the device comprising:
an outer cover bulb removably installed over a non-incandescent light surrounding the non-incandescent light, the outer cover bulb comprising a hollow body portion spaced apart from and completely surrounding the non-incandescent light, the hollow body portion having a first end opening removably attached to a base of the non-incandescent light and a second end opening opposite the non-incandescent light to admit light out of the second end opening, the hollow body portion having a reflective surface to reflect more of the light out of the second end opening for spot light and flood light effects; and a removable replaceable tinted lens removably attached to the hollow body portion covering the second end opening so that the tinted lens creates special lighting effects through the second end opening altering the quality of light output of the non-incandescent light to soften the light, to create incandescent light quality, and to create colored light for special effects, the tinted lens further comprising an exterior frosted surface to hide the non-incandescent light inside the outer cover bulb when the non-incandescent light is not lighted, the tinted lens being replaceable so that any of a variety of tinted lenses may be used interchangeably on the outer cover bulb, the outer cover bulb thereby serving as a non-incandescent light shield and as a light diffusion casing for soft light, incandescent quality light, and special colored lighting effects.

2. The device of claim 1 wherein the outer cover bulb is fabricated of shatterproof polycarbonate to prevent damage to the compact fluorescent tube.

3. The device of claim 1 comprising a conical hollow body portion narrow at the first end opening to fit the non-incandescent light base and wider at the second end opening so that the angle of the conical walls of the hollow body portion reflect light out of the second end opening.

4. The device of claim 1 comprising a cylindrical hollow body portion having an annular end cap over the first end opening with a smaller central opening to fit the base of the non-incandescent light for attachment thereto.

5. The device of claim 4 further comprising a conical reflector attached to the base of the non-incandescent light surrounding the non-incandescent light to reflect light out of the second end opening.

6. The device of claim 5 further comprising a lens assembly comprising a frame structured to fit against a ceiling surface surrounding a recessed lighting opening in a ceiling, the recessed lighting opening housing an existing recessed lighting can having a light fixture socket recessed within the can to hold the non-incandescent light covered by the outer cover bulb in the socket, the frame attached to a light baffle extending into the recessed lighting can, the light baffle having a baffle bottom opening mating with the frame and a baffle top opening for admitting light therethrough the baffle top opening being attached to the second end opening of the cylindrical hollow body portion of the outer cover bulb.

7. The device of claim 6 further comprising a frosted lens attached across the baffle top opening to act as the exterior frosted surface for a tinted lens attached to the outer cover bulb.

8. The device of claim 7 further comprising a series of hooks extending upwardly peripherally around the frame so that the spring hooks contact the can and removably retain the lens assembly in the can with the frame contacting the ceiling.

9. The device of claim 1 wherein the base of the non-incandescent light has a base having a threaded peripheral edge at the bottom of the base and the top end opening of the hollow body portion has a mating interior threaded opening so that the hollow body portion reversibly screws onto and off of the base of the non-incandescent light.

10. The device of claim 1 wherein the top end opening of the hollow body portion further comprises a clamp for removably attaching the outer cover bulb to the base of the non-incandescent light.

11. The device of claim 1 wherein the second end opening of the outer cover bulb has a threaded peripheral edge at the bottom of the outer cover bulb and the replaceable tinted lens has a side wall having a mating interior threaded opening so that the replaceable tinted lens reversibly screws onto and off of the outer cover bulb.

12. The device of claim 1 wherein the second end opening of the outer cover bulb has a recessed peripheral ridge at the bottom of the outer cover bulb and the replaceable tinted lens has a mating interior recessed ridge so that the replaceable tinted lens reversibly snaps onto and off of the outer cover bulb.

13. The device of claim 1 wherein the non-incandescent light base has any of a variety of different connecting ends for fitting into any of a variety of different light sockets.

14. The device of claim 13 wherein the non-incandescent light base has a threaded end for fitting into a threaded light bulb socket.

15. The device of claim 13 wherein the non-incandescent light base has a double pin end for fitting into a double pin receptacle light socket.

16. The device of claim 1 wherein the non-incandescent light comprises any of a variety of types of non-incandescent lights taken from a list of non-incandescent lights comprising a compact fluorescent light, a Light Emitting Diode (LED) light, an energy saving light, a light producing a quality of light output unlike an incandescent light output.
